(19) United States
(12) Patent Application Publication
(10) Pub. No.: US 2025/0353576 A1
(43) Pub. Date: Nov. 20, 2025

(54) REAR WHEEL AXLE, AS WELL AS BICYCLE FRAME AND REAR WHEEL FOR A BICYCLE

(71) Applicant: ADVANCING TECHNOLOGIES B.V., Eindhoven (NL)

(72) Inventors: Roëll Marie VAN DRUTEN, Eindhoven (NL); Johannes Gijsbertus Antonius VAN DEN BRAND, Eindhoven (NL)

(21) Appl. No.: 19/232,303

(22) Filed: Jun. 9, 2025

Related U.S. Application Data
(63) Continuation of application No. 18/063,104, filed on Dec. 8, 2022.
Application No. 18/063,104 is a continuation of application No. 15/122,207, filed on Aug. 29, 2016, now Pat. No. 11,535,337.

(30) Foreign Application Priority Data
Feb. 28, 2014 (NL) 2012340
Apr. 12, 2014 (NL) 2012611

(51) Int. Cl. B62M 9/122; B60B 35/04; B60B 35/08; B62J 45/00; B62J 50/22; B62K 3/02; B62M 1/36; B62M 9/10; B62M 11/16; B62M 25/08

(52) U.S. Cl. CPC B62M 9/122; B60B 35/04; B60B 35/08; B62J 50/22; B62K 3/02; B62M 1/36; B62M 9/10; B62M 11/16; B62M 25/08; B62J 45/00

(57) ABSTRACT

A bicycle includes a transmission having two switchable drives between a driver body on which rear sprockets are positioned and a wheel hub of a rear wheel. The bicycle has actuation elements for switching between drives and operating elements for operating the actuation elements. The bicycle includes only a single front sprocket. The actuation elements are embodied in an electrical version and the operating elements are electrically coupled to the actuation elements. By advantageously selecting the drives of the driver between the cassette housing and wheel hub, a front derailleur may be omitted. The driver allows operation with only little energy, since the chain need not be shifted. consequently, the actuation elements require little energy for changing the drive between the crank axle and the wheel hub of the bicycle, so that it is pre-eminently suitable for these actuation elements and their operation to be executed as an electrical version.

### CROSS REFERENCE TO RELATED APPLICATIONS

This application is a Continuation of application Ser. No. 18/063,104, filed on Dec. 8, 2022, which is a Continuation of application Ser. No. 15/122,207, filed on Aug. 29, 2016, which is the National Phase under 35 U.S.C. § 371 of International Application No. PCT/NL2015/050127, filed on Mar. 2, 2015, which claims the benefit under 35 U.S.C. § 119 (a) to Patent Application Nos. 2012611, filed in the Netherlands on Apr. 12, 2014 and 2012340, filed in the Netherlands on Feb. 28, 2014, all of which are hereby expressly incorporated by reference into the present application.

### FIELD OF THE INVENTION

The invention relates to a bicycle comprising:
a frame comprising a front fork and a rear fork, as well as an axle housing,
a front wheel and a rear wheel fitted to the front and rear fork respectively,
a drive axle which is bearing-mounted in the axle housing,
at least a single front sprocket which is connected to the drive axle,
at least a single rear sprocket which is connected to a wheel hub of the rear wheel,
a chain threaded around the front and rear sprocket,
a transmission comprising at least two drives between the drive axle and the rear wheel hub and provided with actuation means for switching between the drives, and
operating means for operating the actuation means,
   where the actuation means of the transmission are electrically actuated and the operating means are electrically coupled to the actuation means, and
   where a storage element for storing electrical energy is coupled to the actuation means and/or operating means.

The electrical coupling of the operating means to the actuation means may in this case be arranged as a wired coupling or a wireless coupling.

When a drive axle is concerned there may be thought of a crank axle where the axle housing in that case is formed by a crank axle housing.

When an electrical energy storage element is concerned there may be thought of a battery or a capacitor.

It is advantageous to electrically actuate the switching mechanism for changing the drive between the crank axle and the wheel hub. As a consequence of this there is no need for a mechanical connection between the operating buttons/levers and the switching mechanism.

### STATE OF THE ART

A bicycle of this type is known from U.S. Pat. No. 6,354,980 B1. A disadvantage of an electrically actuated and operated transmission is that the battery or batteries are to be replaced on a regular basis. Usually they are not replaced until it has been experienced that they do not supply a sufficient amount of current and at that moment no new batteries are available, so that temporarily no switching can be performed.

### SUMMARY OF THE INVENTION

It is an object of the invention to provide a bicycle of the type defined in the opening paragraph where said disadvantage does not occur. For this purpose, the bicycle according to the invention is characterized in that the bicycle comprises a generator or current generating means which converts/convert motion energy to current, as well as a charger connected to this generator or current generating means and to the electrical energy storage element for charging the storage element. The generator is preferably arranged as a micro generator. The storage element is automatically recharged, so that always a sufficient amount of energy is available for switching. Application of such micro generators or energy generating means (kinetic energy harvesting system) is possible if the current consumption of the actuators is sufficiently low and switching does not take place on a continuous basis but in between switching operations some time is left for the battery to be recharged, such as for example, when switching the transmission.

Preferably, the generator or the current generating means which converts/convert motion energy to current is/are connected to the wheel hub and/or the wheel axle.

An advantageous embodiment of the bicycle according to the invention is characterized in that the storage element for storing electrical energy is connected to the wheel axle. Since the storage element need no longer be replaced on a regular basis, it may advantageously be fitted close to the actuation means, so that the chance of undesired interruption of the connection between the storage element and the actuation means is strongly reduced.

A further advantageous embodiment of the bicycle according to the invention is characterized in that:
the transmission is present between the rear sprocket and the wheel hub of the rear wheel,
the wheel hub and the transmission are positioned on a hollow wheel axle, and
an axle shaft is inserted through the hollow wheel axle via which axle shaft the wheel axle is connected to the rear fork.

An advantage of this construction is that the hollow wheel axle creates opportunities for accommodating or connecting component parts such as electrical conductors for coupling the actuation means to the operating means.

It should be observed that this embodiment also allows of being applied to a bicycle that is not equipped with a generator or current generating means, and can thus also be applied advantageously to a bicycle in which the storage element does have to be replaced on a regular basis.

A still further embodiment of the bicycle according to the invention is characterized in that:
seen in axial direction of the wheel axle, the transmission is chiefly positioned outside rear wheel spoke flanges,
the transmission actuation means are positioned inside a driver body of the transmission,
the hollow wheel axle comprises two separate axle parts, where the wheel hub is positioned on a first one of the two axle parts and the transmission is positioned on a second one of the two axle parts, and
   where the axle shaft is inserted only through the first axle part and the second axle part is connected to the rear fork.

An advantage of this construction is that when the rear wheel is to be changed, no electrical conductors need be interrupted. Furthermore, with this construction it is no longer necessary to uncouple the chain from the the rear wheel when the rear wheel is taken out.

Again a further advantageous embodiment of the bicycle according to the invention is characterized in that the bicycle comprises only a single front sprocket. Electrical actuation of the adjusting mechanism for changing the transmission ratio between the front sprockets usually requires relatively much energy which in turn requires a relatively large battery. More particularly shifting the chain from one to the next sprocket present on the crank axle costs relatively much energy since there is a large difference in diameter between the front sprockets and since the chain is under stress in the place of the shifting mechanism. By inserting a transmission between the rear sprocket and the wheel hub, a front derailleur may be dispensed with. The transmission allows of being operated with relatively little energy since for this operation no chain needs to be shifted. As a result, the actuation means for changing the transmission between the crank axle and the wheel hub of the bicycle according to the invention require little energy, so that it is pre-eminently suitable for these actuation means and the operation of them to be executed electrically and to retain a small required battery.

A further advantageous embodiment of the bicycle according to the invention is characterized in that:
the axle shaft is releasably connected to the wheel axle and in tangential direction is fixed relative to the wheel hub by means of a releasable form locked connection;
the axle shaft is furthermore releasably connected to a drop out of the rear fork and in tangential direction is fixed relative to the drop out by means of a releasable form locked connection, and
the axle shaft is provided with electrical conductors having contact points at their ends, of which the contact points at an end seen in axial direction of the wheel axle are present between the drop outs of the rear fork and make contact with contact points of further conductors connected to the actuation means and the contact points at the other end of the electrical conductors of the axle shaft seen in axial direction of the wheel axle are present outside the drop outs and make contact with further contact points of further electrical conductors connected to the bicycle frame which are coupled to the operating means.

An advantage of this construction is that via the axle shaft both the torque support and the electrical connection is realised, as a result of which only the axle shaft needs to be removed when the rear wheel is changed and no separate action need be taken for mechanically and electrically decoupling the parts.

The bicycle preferably comprises an electrically actuated rear derailleur and the operating means are further electrically coupled to further actuation means of the rear derailleur. As a result of this, the complete gear mechanism of the bicycle is arranged electrically and the electrical wiring can be installed on one side of the frame, so that little electrical wiring will suffice.

The operating means are coupled preferably in a wireless manner to the actuation means of the transmission and/or the rear derailleur. In consequence, there is no need for electrical conductors to be fitted between the operating means and the actuation means on or in the frame of the bicycle.

A still further advantageous embodiment of the bicycle according to the invention is characterized in that the bicycle comprises a control unit which controls the derailleur and/or the transmission based on an entered desired drive between crank axle and wheel hub. As a result, the user need not separately select the drive and the shifting of the chain to another rear sprocket, but this can be executed automatically by the control unit.

A further advantageous embodiment of the bicycle according to the invention is characterized in that the operating means comprise an operating button which is fitted to the handlebars of the bicycle, as well as a display or indicator that shows the gear selected by the transmission. The user himself, it is true, is to select the drive of the transmission and the shifting of the chain on the rear sprockets, but he is assisted for this action by the indication of the drive that has been selected.

### BRIEF DESCRIPTION OF THE DRAWING FIGURE

The invention will be further described hereinbelow in more detail with reference to an example of embodiment represented in the drawings of a rear wheel axle of a bicycle comprising a wheel hub and a driver according to the invention, in which drawings:

FIG. 1 shows an embodiment of the bicycle according to the invention;

FIG. 2 shows a sectional view of a wheel axle of a rear wheel axle with mounted to it a wheel hub and a driver;

FIG. 3 and FIG. 4 show different preferred positions of the operable pawls in the couplings connected to the planetary gear set;

FIG. 5 shows a sectional view of the rear wheel axle where the wheel axle and axle shaft are locked in drop outs;

FIG. 6 shows a sectional view of the separate wheel axle of the rear wheel axle locked in the drop out;

FIG. 7 shows a sectional view of the drop outs of a rear fork of a wheel axle of another rear wheel axle taken out of a bicycle frame;

FIG. 8 shows a sectional view of the separate axle shaft of the rear wheel axle;

FIG. 9 shows a perspective view of the drop outs shown in FIG. 7;

FIG. 10 shows a sectional view of a wheel axle of another rear wheel axle of the bicycle according to the invention; and

FIG. 11 shows a a sectional view of a wheel axle of yet another rear wheel axle of the bicycle according to the invention.

### DETAILED DESCRIPTION OF THE DRAWING FIGURES

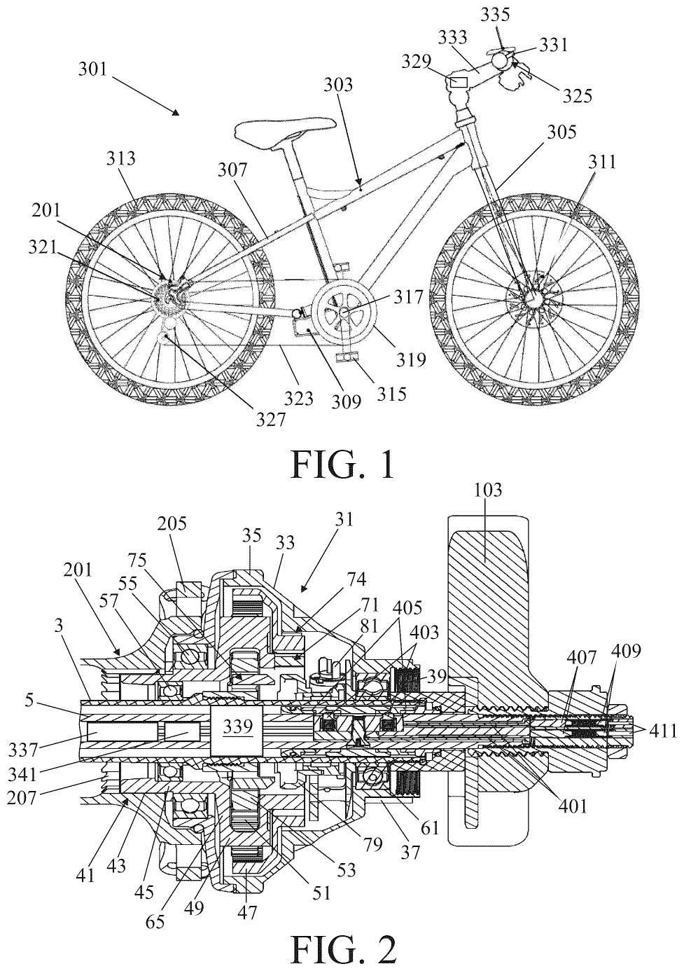

FIG. 1 shows an embodiment of the bicycle according to the invention. The bicycle 301 comprises a frame 303 equipped with a front fork 305 and a rear fork 307, as well as a crank axle housing 309, a front wheel and a rear wheel 311, 313 located in the front and rear fork respectively, pedals 315 which are connected to a crank axle 317 which is bearing-mounted in the crank axle housing 309, a front sprocket 319 which is connected to the crank axle 317, a plurality of rear sprockets 321 which are connected to a driver body 33 which is connected to a wheel hub 201 of the rear wheel 313, a chain 323 threaded over the front sprocket and one of the rear sprockets, a driver 31 including at least two switchable drives between the driver body 33 and the wheel hub 201 of the rear wheel 313 and which driver is provided with actuation means 81 (see FIG. 2) for switching between the drives, and operating means 325 for operating the actuation means.

The bicycle 301 comprises no more than a single front sprocket 319 and the actuation means 81 of the driver 31 are arranged in an electrical version and the operating means 325 are electrically coupled to the actuation means. The bicycle 301 comprises an electrically actuated rear derailleur 327 and the operating means 325 are furthermore electrically coupled to the actuation means 81 of the rear derailleur.

The operating means 325 are coupled in a wireless manner to the actuation means 81 of the driver 31 and/or the rear derailleur 327. The bicycle further includes a control unit 329 for controlling the rear derailleur 327 and/or the driver 31 based on an entered desired drive between crank axle 317 and wheel hub 201. The operating means 325 comprise an operating button 331 which is fitted to the handlebars 333 of the bicycle, as well as a display 335 or indicator indicating the gear the driver is in.

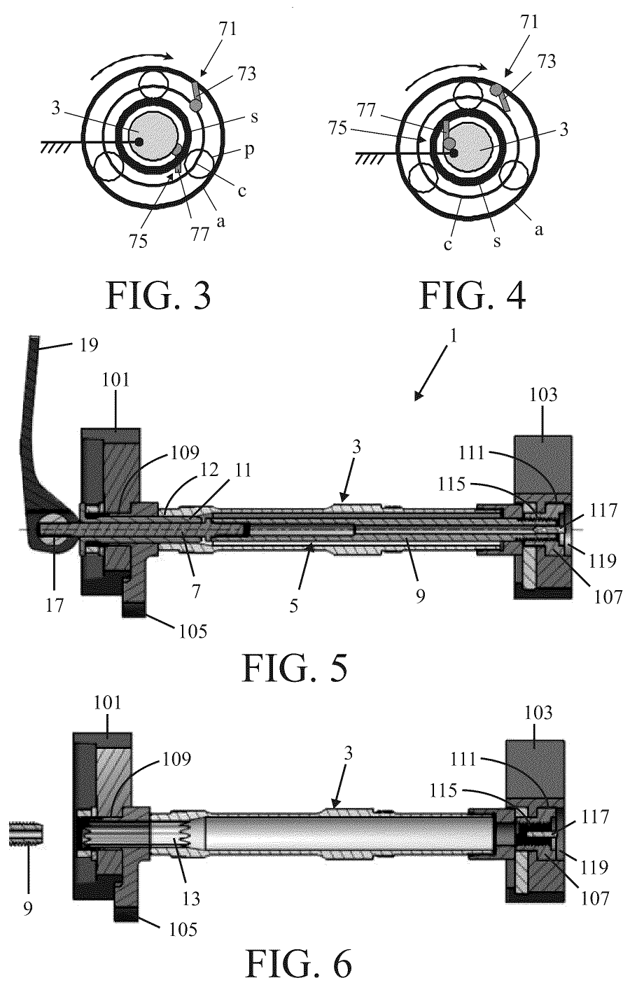

FIG. 2 shows a sectional view of a wheel axle 3 of a rear wheel axle with bearing-mounted on it a wheel hub 201 and a driver 31 according to the invention connected to the wheel axle and the wheel hub. The wheel axle 3 is hollow and at one end (the end not represented in FIG. 2) is provided with internal splines for a form locked connection to one of the drop outs of a rear fork of a bicycle frame (see FIG. 3). Via this form locked connection the wheel axle can support torque, which torque is a reaction torque of the drives between a driver body 33 of the driver and the wheel hub 201. The wheel hub 201 and the driver 31 connected to it are bearing-mounted on the wheel axle 3. The wheel hub has two spoke flanges 205 to which spokes (not shown) of a wheel are fitted. A sprocket carrier (not shown) with sprockets fitted to it can be installed on the driver body 33 of the driver 31. To this end the driver body 33 is provided with connecting means (splines 35, 37 and internal thread 39) via which the sprocket carrier provided with further connecting means can be connected to the driver body.

The driver 31 comprises two switchable drives between the driver body 33 and the wheel hub 201, as a result of which only a single sprocket on the crank axle will suffice, and a front derailleur of a bicycle may thus be omitted. The driver 31 is coupled via splines 41 to the wheel hub 201. These splines comprise internal splines 207 present in the wheel hub and external splines 43 on an output coupling bush 45 of the driver. The driver 31 together with the hollow wheel axle 3 to which it is attached forms a unit which can be inserted as a whole into the wheel hub 201 and together with the wheel hub (and the rest of the rear wheel the wheel hub forms part of) can be pushed in between drop outs 101 and 103 of a rear fork of a bicycle frame and also taken out.

The driver 31 comprises a planetary gear set having three rotational members, of which a first rotational member is formed by an annulus gear 47, a second rotational member is formed by a planet gear support 49 to which a plurality of planet gears 51 are bearing-mounted and which is connected to coupling means formed by the coupling bush 45 that has external splines 43, and a third rotational member is formed by a sun gear 53 which is connected to the wheel axle 3.

The first rotational member 47 is connected to the second rotational member 51 via a first switchable coupling 71 and the third rotational member 53 is connected to a second switchable coupling 75 via which the third rotational member can be connected to the wheel axle 3. The driver 31 further includes a switching mechanism for switching the switchable couplings 71 and 75. The switching mechanism is located in the space 81 within the driver body 33 and has a sliding ring 79 which by axial displacement can operate the two couplings. The switching mechanism further includes an electrical actuator for displacing the sliding ring 79. This actuator has a stator which is mounted to the wheel axle 3.

The sliding ring 79 and the actuator are present in the driver body 33 on the planetary gear set side turned away from the coupling means 41. The actuator is provided with connecting pins which protrude into the wheel axle 3 through one or more openings and are isolated from the wheel axle.

The axle shaft is provided with electrical conductors 401 which have contact points at their ends, of which the contact points 403 at an end seen in axial direction of the wheel axle are present between the drop outs 101 and 103 of the rear fork 307 and make contact with contact points of further conductors 405 connected to the actuation means and the contact points 407 are present at the other end of the electrical conductors of the axle shaft seen in axial direction of the wheel axle outside the drop outs 101 and 103 and make contact with further contact points 409 of further electrical conductors 411 connected to the bicycle frame and which are coupled to the operating means.

FIGS. 3 and 4 show two variants of operable pawls 73 and 77 of the couplings 71 and 75 in the planetary gear set. In this gear set the annulus gear is driven and planet gear support c forms the output. The sun gear s can be coupled to the wheel axle 3. FIG. 3 shows a first embodiment of the planetary gear set provided with operable pawls 73 and 77. The wheel axle 3 is in this case fixed to the frame of the bicycle. Pawl 77 is rotatably connected to the wheel axle 3 and is in engagement with the sun gear s. Pawl 73 is rotatably connected to the planet gear support c and is in engagement with annulus gear a.

FIG. 4 shows a second embodiment of the planetary gear set provided with operable pawls 73 and 77. Here the wheel axle 3 is fixed to the frame of the bicycle. Pawl 77 is rotatably connected to the wheel axle and is in engagement with the sun gear s. Pawl 73 is rotatably connected to the annulus gear a and is in engagement with the planet gear support c.

Between the coupling means (coupling bush 45) and the driver body 33 is located a first sealing which is formed by a left hand sealed driver body bearing 55 (first sealed ball bearing) whose outer peripheral side is connected to the driver body and whose inner peripheral side is connected to the coupling means (coupling bush 45). Between the coupling means (coupling bush 45) and the wheel axle 3 is located a second sealing which is formed by a support bearing 57 (scaled needle bearing). The scaling ring 59 of the support bearing is connected with its outer peripheral side to the coupling means (coupling bush 45). Between the driver body 33 and the wheel axle 3 is located a third scaling which is formed by a right-hand sealed driver body 61 (second sealed ball bearing) whose outer peripheral side is connected to the driver body. The outer peripheral side of the support bearing 57 is connected to the coupling means (coupling bush 45) and is present between the second and third sealing. The rollers 61 of the support bearing run over a roller face 63 present on the wheel axle 3.

The coupling means which are formed by the coupling bush 45 provided with external splines cooperate with further coupling means which are formed by the internal splines 207 present in the wheel hub 201. At the other end the coupling bush 45 is provided with a flange 65 which forms part of or is connected to the second rotational member. The left-hand driver body 55 is present here between the external splines 43 and the flange 65 on the coupling bush 45. The wheel hub 201 is bearing-mounted on the wheel axle 3 near a first end through a wheel hub bearing (not shown in the Figures) and at a second end is provided with the further coupling means which are formed by the internal splines 207.

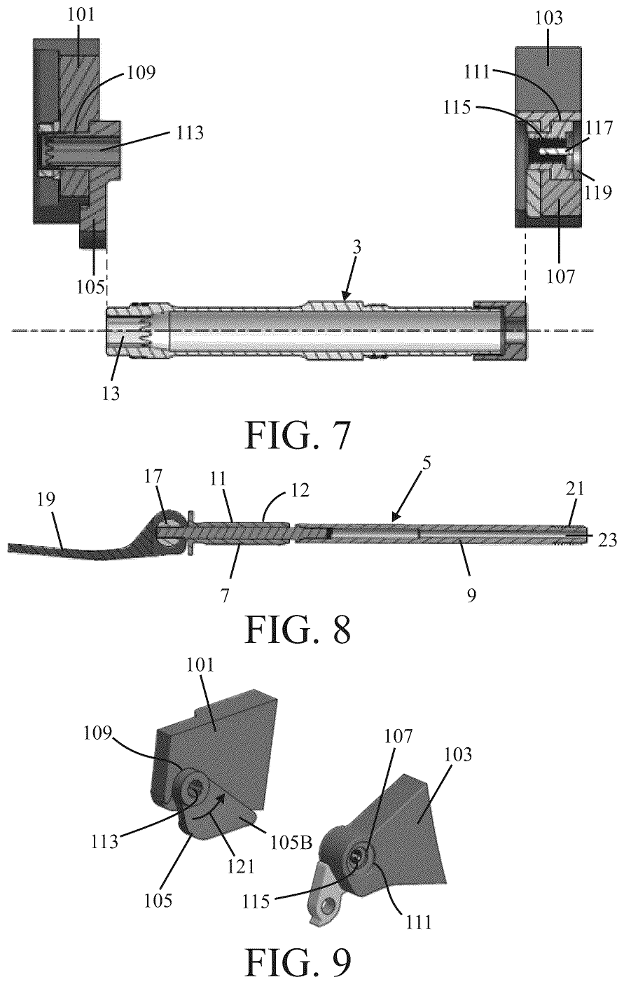

FIG. 5 shows a sectional view of the rear wheel axle 1 fixed to the drop outs 101 and 103 of the rear fork of a bicycle. The rear wheel axle I comprises the hollow wheel axle 3 accommodating an axle shaft 5 inserted through it. The rear wheel axle comprises torque support means for supporting on a bicycle frame the torque exerted on the wheel axle. These torque support means are formed by internal splines 13 in the left-hand end of the hollow wheel axle (see FIGS. 4 and 5), internal splines 113 in a torque support arm 105 which is present in an opening 109 in the left-hand drop out 101 and which rests against the drop out (see FIG. 9), and external splines 12 (see FIGS. 5 and 8) on a bush 11 freely rotatable around a pin 7. The internal splines 13 in the wheel axle 3 and the right-hand part of the bush 11 here form a first form locked connection and the internal splines 113 in the torque support arm 105 and the left-hand part of the bush 11 form a second form locked connection. After removing the axle shaft 5 by removing same in axial direction from the wheel axle, the wheel axle 3 can be removed in radial direction from between the drop outs 101 and 103 of the rear fork (see FIG. 7).

The pin 7 with the bush 11 freely rotating around it and with a further pin 9 connected to the pin 7 via a threaded connection jointly form the axle shaft 5 (see FIG. 8). The axle shaft has at its left end a lever 19 which is eccentrically connected to an axle 17 mounted to the end of the pin 7 and forms a quick release mechanism (see FIG. 9) for clamping the wheel axle 3 between the drop outs 101 and 103 of a bicycle frame. The free end of the further pin 9 is provided with external thread 21 which is turned into a cap 107 present in an opening 111 in the right-hand drop out 103, which cap has internal thread.

The further pin 9 has at its threaded end 21 a central recess 23 whose inside wall is provided with two electrical contacts which are present side by side in axial direction. The right-hand drop out 103 is provided with a cap 117 (see FIG. 7) which through a bridge plate 119 is connected to the cap 107 and extends in the middle of the opening 111 and forms an extender provided with two further electrical contacts which are present side by side in axial direction and are in contact with the contacts in the right-hand end of the further pin 9 of the axle shaft 5.

FIG. 9 shows by way of illustration the drop outs 101 and 103 in a perspective view. The openings 109 and 111 in the drop outs accommodate inserts in the form of a torque support arm 105 that is provided with internal splines 113 and a hollow cap 107 that is provided with internal thread 115. An end 105B of the torque support arm 105 rests against the drop out 101 in the direction of rotation 121 so that this drop out 101 is locked against rotation and can thus support torque.

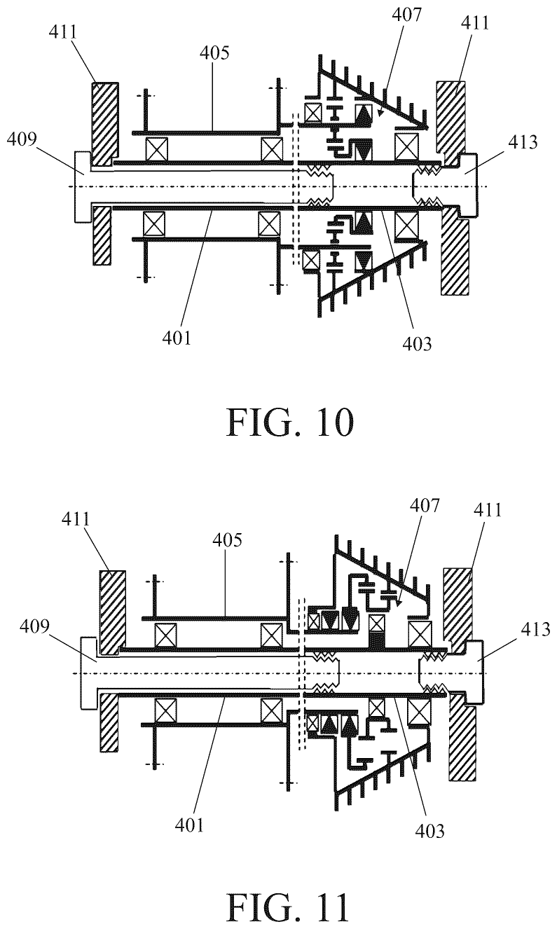

FIGS. 10 and 11 show sectional views of rear wheels of two further embodiments of the bicycle according to the invention. The hollow wheel axle here comprises a first axle part 401 where the wheel hub is located, as well as a second axle part 403 where the driver 407 is located. The axle shaft 409 is inserted only through the first axle part 401 and the second axle part 403 is connected to the rear fork 411 by means of a bolt 413. The rear wheel can be removed from the rear fork by releasing the axle shaft and removing it from the first axle part, while the second axle part with the driver present on it continues to be connected to the rear fork. In FIG. 11 the drive is arranged as a planetary gear set having only a single planet gear 407 which is bearing-mounted eccentrically relative to the stationary wheel axle. The planetary gear set has a stepped design (consists of two different diameters of gears that are coupled to each other). A first one of the two planet gear diameters is in engagement with an annulus gear which is connected to the driver body. A second one of the two planet gear diameters is in engagement with an annulus gear which can be connected to the wheel hub. This embodiment of the planetary gear set enables the realisation of a very small step in transmission ratio, which may be advantageous for certain applications.

Albeit the invention has been elucidated in the foregoing with reference to the drawings, it should be set out that the invention is not by any manner or means restricted to the embodiments shown in the drawing figures. The invention also extends to any embodiments deviating from the embodiments shown in the drawing figures within the scope defined by the claims.

1. An axle shaft comprising:
an elongate body configured for insertion into a hollow bicycle wheel axle of a bicycle;
for releasably connecting the wheel axle to a fork of the bicycle, and
a storage element for storing electrical energy provided within the elongate body.

2. The axle shaft of claim 1, wherein the storage element is rechargeable.

3. The axle shaft of claim 1, further comprising a charger connected to the storage element for charging the storage element.

4. The axle shaft of claim 1, wherein the storage element comprises a battery.

5. The axle shaft of claim 1, further comprising electrical conductors having contact point at their ends, said contact point being accessible from outside the axle shaft.

6. A bicycle rear axle assembly, including:
a hollow wheel axle;
an axle shaft inserted in the hollow wheel axle for releasably connecting the wheel axle to a fork of the bicycle;
wherein the axle shaft includes a storage element for storing electrical energy.

7. The bicycle rear axle assembly of claim 6, wherein the axle shaft comprises an elongate body inserted into the hollow wheel axle, wherein the storage element is included in the elongate body.

8. The bicycle rear axle assembly of claim 6, further comprising a generator or current generating means, configured for converting motion energy to electrical current, connected to the storage element for charging the storage element.

9. The bicycle rear axle assembly of claim 8, further comprising a charger connected to the generator or current generating means and to the storage element for charging the storage element.

10. The bicycle rear axle assembly of claim 6, further comprising electrical conductors having contact point at their ends, said contact point being accessible from outside the axle shaft.

11. The bicycle rear axle assembly of claim 6, further comprising:
a wheel hub;
a driver body;
a transmission including at least two drives between the driver body and the wheel hub, said transmission provided with an electric actuator of the transmission for switching between the at least two drives, the wheel hub and the transmission being positioned on the hollow wheel axle.

12. A bicycle comprising:
a hollow wheel axle;
an axle shaft inserted in the hollow wheel axle for releasably connecting the wheel axle to a fork of the bicycle;
wherein the axle shaft includes a storage element for storing electrical energy.

13. The bicycle of claim 12, wherein the axle shaft comprises an elongate body inserted into the hollow wheel axle, wherein the storage element is included in the elongate body.

14. The bicycle of claim 12, further comprising a generator or current generating means, configured for converting motion energy to electrical current, connected to the storage element for charging the storage element.

15. The bicycle of claim 14, further comprising a charger connected to the generator or current generating means and to the storage element for charging the storage element.

16. The bicycle of claim 12, further comprising:
a frame with a rear fork, wherein the axle shaft is inserted in the hollow bicycle wheel axle and releasably connects the wheel axle to the rear fork;
a wheel hub;
a rear sprocket for driving a driver body in rotation;
the driver body being connected to the wheel hub via a transmission, for driving the wheel hub in rotation;
the transmission including at least two drives between the driver body and the wheel hub, said transmission provided with an electric actuator of the transmission for switching between the at least two drives, the wheel hub and the transmission being positioned on the hollow wheel axle.

17. The bicycle of claim 16, further comprising operating means wiredly or wirelessly connected to the actuator of the transmission, for operating the actuator.

18. The bicycle claim 16, wherein the hollow wheel axle or axle shaft further comprises electrical conductors having contact point at their ends, said contact point being accessible from outside the axle shaft.

19. The bicycle of claim 16, further comprising an electrically actuatable rear derailleur.

20. The bicycle of claim 19, comprising a control unit connected to the operating means and the actuator, configured for controlling rear derailleur and/or the transmission based on an entered desired drive between a crank axle and the wheel hub.
